(19) United States
(12) Patent Application Publication
(10) Pub. No.: US 2025/0238678 A1
(43) Pub. Date: Jul. 24, 2025

(54) Intelligent Iterative Multi-version Extractor

(71) Applicant: Bank of America Corporation, Chorlotte, NC (US)

(72) Inventors: Deepiga Venkatachalam, Chennai (IN); Sreeram Raghavan, Chennai (IN)

(21) Appl. No.: 18/421,359

(22) Filed: Jan. 24, 2024

(51) Int. Cl. G06N 3/091; G06N 3/0464

(52) U.S. Cl. CPC G06N 3/091; G06N 3/0464

(57) ABSTRACT

Arrangements for efficiently storing a versioned file are provided. A computing platform may train a convolutional neural network to create a plurality of encoded vectorized outputs corresponding to the plurality of versions of a file. The computing platform may train the convolutional neural network to create a plurality of delta vectors, which may be used to obtain a previous version of the file from a newer version of the file. The computing platform may receive a request to obtain a previous version of the file. The computing platform may use the convolutional neural network to output the previous version of the file from the newest encoded vectorized output.

### BACKGROUND

Aspects of the disclosure relate to storing files/documents (e.g., a text file, audio file, video file, software document, etc.), in which there may multiple versions of any given file. As the information in a file is edited and/or modified, new versions of the file are subsequently created. Storage of a versioned file (e.g., multiple versions of a file) may exponentially increase memory usage and associated costs as new versions of the file are created. Currently, storing a versioned file or many versioned files may require significant resources and further may not be secure. Accordingly, it may be advantageous to identify more effective and efficient methods to store a versioned file that may be accessed on-demand.

### SUMMARY

Aspects of the disclosure provide effective, efficient, scalable, and convenient solutions that address and overcome the technical problems associated with storing versioned information. In accordance with one or more aspects of the disclosure, a computing platform with at least one processor, a communication interface communicatively coupled to the at least one processor, and memory storing computer-readable instructions may train, based on a plurality of versions of a file, a convolutional neural network, in which training the convolutional neural network may configure the convolutional neural network to create a plurality of encoded vectorized outputs corresponding to the plurality of versions, in which each of the plurality of encoded vectorized outputs may include a one-dimensional vector that corresponds to a respective encoded vectorized output. The computing platform may create a plurality of delta vectors, in which each of the plurality of delta vectors corresponds to differences between successive versions of the file and may be used to obtain a previous version from a newer version. The computing platform may store, at a first repository, a newest encoded vectorized output. The computing platform may receive, from a user device, a request to obtain a previous version of the file. The computing platform may send, based on the request, one or more commands directing the first repository to send the newest encoded vectorized output to the computing platform, which may cause the first repository to send the newest encoded vectorized output to the computing platform. The computing platform may receive, from the first repository, the newest encoded vectorized output. The computing platform may input the newest encoded vectorized output into the convolutional neural network. The computing platform may output, using the convolutional neural network, the previous version of the file from the newest encoded vectorized output using a corresponding delta vector of the plurality of delta vectors. The computing platform may send, to the user device, the previous version of the file and one or more commands directing the user device to display the previous version of the file, which may cause the user device to display the previous version of the file.

In one or more instances, the computing platform may receive, from a second repository, a first version of the file and a second version of the file, in which the first version and the second version may be successive versions of the file. The computing platform may input, into the convolutional neural network, the first version and the second version. The computing platform may create, using the convolutional neural network, a first encoded vectorized output corresponding to the first version and a second encoded vectorized output corresponding to the second version. The computing platform may create, using the convolutional neural network, a first delta vector between the first encoded vectorized output and the second encoded vectorized output, in which the first delta vector may be used to obtain the first version from the second version. The computing platform may store, at the first repository, the second encoded vectorized output.

In one or more examples, the convolutional neural network may further include a first layer and a second layer, in which each of the first layer and the second layer may reduce a dimensionality of each of the plurality of versions. In one or more instances, creating the plurality of encoded vectorized outputs may be performed iteratively until a reconstruction loss threshold is reached so that each of the plurality of encoded vectorized outputs may be used to output the corresponding plurality of versions.

In one or more instances, creating the plurality of delta vectors may be performed iteratively until a reconstruction loss threshold is reached that may enable each of the plurality of delta vectors to be used to obtain previous encoded vectorized outputs from successive encoded vectorized outputs.

In one or more examples, the computing platform may store the plurality of versions of the file at a second repository. In one or more instances, the computing platform may store the plurality of delta vectors at a bottleneck associated with the convolutional neural network. In one or more examples, the computing platform may pre-process the plurality of versions of the file before training the convolutional neural network, in which the pre-processing may include converting the plurality of versions of the file into a machine-readable format by tokenizing the plurality of versions of the file.

In one or more instances, the computing platform may receive, from the second repository, a third version of the file, in which the third version is a successive version of the second version of the file. The computing platform may input, into the convolutional neural network, the third version. The computing platform may create, using the convolutional neural network, a third encoded vectorized output corresponding to the third version. The computing platform may create, using the convolutional neural network, a second delta vector between the second encoded vectorized output and the third encoded vectorized output, in which the second delta vector may be used to obtain the second version from the third version.

In one or more instances, the computing platform may send the third encoded vectorized output and one or more commands directing the first repository to replace the second encoded vectorized output with the third encoded vectorized output, which may cause the first repository to replace the second encoded vectorized output with the third encoded vectorized output.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing an intelligent iterative multi-version extractor in accordance with one or more example embodiments;

FIGS. 2A-2I depict an illustrative event sequence for implementing an intelligent iterative multi-version extractor in accordance with one or more example embodiments;

FIGS. 3-5 depict illustrative methods for implementing an intelligent iterative multi-version extractor in accordance with one or more example embodiments; and

FIG. 6 depicts an illustrative graphical user interface for implementing an intelligent iterative multi-version extractor in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect. As a brief introduction to the concepts described further herein, one or more aspects of the disclosure relate to efficiently storing a versioned file.

The increase in digital information may cause issues with the storage and management of data. Further, adding new versions of any given file may increase the issues exponentially. There may be a severe strain on infrastructure used to store all the versions of a file without sacrificing the performance of storage systems that makeup the infrastructure. Further, as a volume of information being stored increases, it may be more difficult for existing infrastructure to manage the information effectively. Protecting information from unauthorized access may also be a concern. Information/file loss due to corruption, accidental deletion, natural disasters, and cyber attacks may give rise to a need to effectively retrieve the “lost” information. Archived, versioned sets of files may be preserved over long periods of time across changing storage formats and may also need to be retrieved efficiently on demand.

Accordingly, described herein is a deep learning approach for identifying efficient use of spatial dimensionality that may be required for iterative multi-version file retrieval from a singular source, which may in turn facilitate alternate means for securely storing, archiving, and extracting any version of the file. The solution may be an end-end hierarchical stacked convolutional auto encoder-based processing platform that may reduce the dimensionally of each version of the file into a vector representation output that may be used to extract and/or reconstruct any version of the input.

Accordingly, an intelligent iterative unsupervised learning process may enable extraction of earlier versions of the file from a single latest version by deriving dimensionally reduced encoded vectors for each version and its immediate predecessor. Stacked encoding and decoding may enable identifying and/or reducing spatial dimensionality for full extraction of the input being processed as well as its predecessor. Encoded numerical vector representation storage may enhance security, reduce storage space, and may facilitate faster on-demand extraction and access.

Accordingly, when a new version of a file is introduced, the hierarchical scaled convolutional auto-encoder (SCAE) may be trained to vectorize, convolve and extract the original input from the encoded vectors. The entire process may be trained until the reconstruction loss may fall below an acceptable threshold. Once the step above is completed for each new version, based on the version linkages metadata, an engine may intelligently iterate through the version and may train the hierarchical SCAE to regenerate the earlier version from the latest version. This may be achieved by feeding the latest version (which may be the desired earlier version plus noise) as an input and by comparing the decoder output with the earlier version for which extraction is being processed, until the process may be trained to extract the target version and the reconstruction loss falls below the acceptable threshold. The encoder output, which may be a hierarchical vector representation that is dimensionally reduced, may be stored for extracting the original at any desired time. Once the process is learned fully, the required vectorized output from the encoder may be securely stored for efficient on-demand extraction.

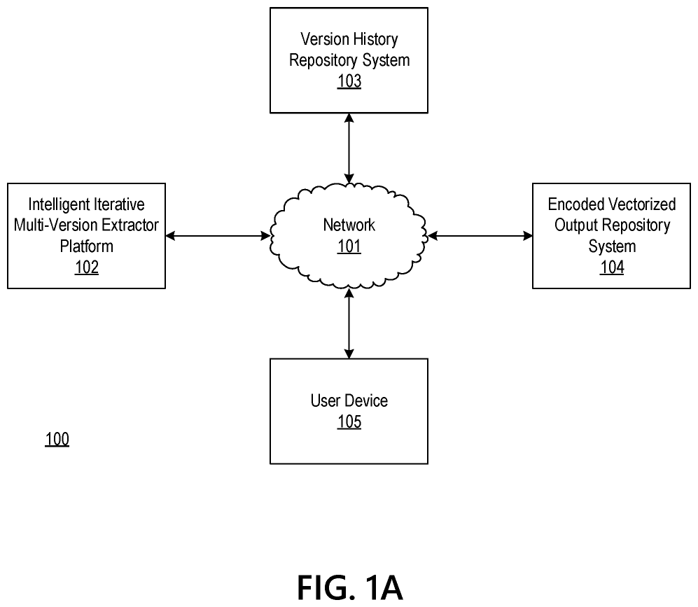

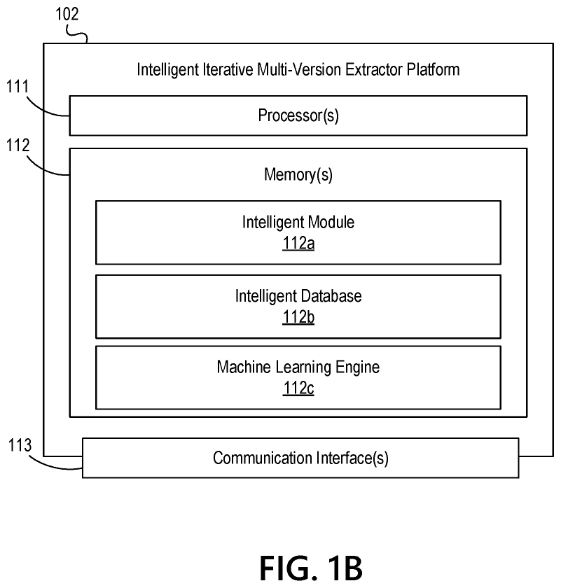

FIGS. 1A-1B depict an illustrative computing environment for implementing an intelligent iterative multi-version extractor in accordance with one or more example embodiments.

Referring to FIG. 1A, computing environment 100 may include one or more computer systems. For example, computing environment 100 may include an intelligent iterative multi-version extractor platform 102, a version history repository system 103, an encoded vectorized output repository system 104, and a user device 105.

As described further below, intelligent iterative multi-version extractor platform 102 may be a computer system that includes one or more computing devices (e.g., servers, server blades, or the like) and/or other computer components (e.g., processors, memories, communication interfaces) that may be used to train, host, configure, and/or otherwise refine a machine learning engine, which may be used to process a versioned file, create an encoded numerical vector representation of each version of the file, reconstruct any version of the file from the encoded numerical vector representation, and/or perform other functions.

Version history repository system 103 may be or include one or more computing devices (e.g., servers, server blades, or the like) and/or computer components (e.g., processors, memories, communication interfaces, and/or other components). In some instances, version history repository system 103 may include one or more data sources that may store a plurality of versions of a file (e.g., a text file, audio file, video file, software documents and/or other types of files) that may be sent to intelligent iterative multi-version extractor platform 102 to train the machine learning engine, as discussed in more detail below. In some instances, version history repository system 103 may link versions of the file together based on metadata associated with the versioned file.

Encoded vectorized output repository system 104 may be or include one or more computing devices (e.g., servers, server blades, or the like) and/or computer components (e.g., processors, memories, communication interfaces, and/or other components). In some instances, encoded vectorized output repository system 104 may store and/or send an encoded vectorized output corresponding to a particular version of the file, and/or perform other functions, as discussed in more detail below.

In some instances, version history repository system 103 and encoded vectorized output repository system 104 may use and/or otherwise be integrated into a same physical computing device. In some instances, version history repository system 103 and encoded vectorized output repository system 104 may use and/or otherwise be integrated into different computing devices. In some instances, version history repository system 103 and encoded vectorized output repository system 104 may support cloud infrastructure.

User device 105 may be a laptop computer, desktop computer, mobile device, tablet, smartphone, and/or other device, which may host, run, or otherwise request a particular version of a file. In some instances, user device 105 may be a user computing device that is used by an individual. In some instances, user device 105 may be an enterprise computing device that is used by an administrator to request any given version of a versioned file. In some instances, user device 105 may be configured to display one or more user interfaces (e.g., interfaces depicting a particular version of the file, or the like). Although only a single user device 105 is depicted, this is for illustrative purposes only, and any number of user devices may be implemented in the environment 100 without departing from the scope of the disclosure.

Computing environment 100 also may include one or more networks, which may interconnect intelligent iterative multi-version extractor platform 102, version history repository system 103, encoded vectorized output repository system 104, and user device 105. For example, computing environment 100 may include a network 101 (which may interconnect, e.g., intelligent iterative multi-version extractor platform 102, version history repository 103, encoded vectorized output repository 104, and user device 105, and/or other computing devices).

In one or more arrangements, intelligent iterative multi-version extractor platform 102, version history repository system 103, encoded vectorized output repository system 104 and user device 105 may be any type of computing device capable of sending and/or receiving requests and processing the requests accordingly. For example, intelligent iterative multi-version extractor platform 102, version history repository system 103, encoded vectorized output repository system 104, user device 105, and/or the other systems included in computing environment 100 may, in some instances, be and/or include, server computers, desktop computers, laptop computers, tablet computers, smart phones, or the like that may include one or more processors, memories, communication interfaces, storage devices, and/or other components. As noted above, and as illustrated in greater detail below, any and/or all of intelligent iterative multi-version extractor platform 102, version history repository system 103, encoded vectorized output repository system 104 and user device 105 may, in some instances, be special-purpose computing devices configured to perform specific functions.

Referring to FIG. 1B, intelligent iterative multi-version extractor platform 102 may include one or more processors 111, memory 112, and communication interface 113. A data bus may interconnect processor 111, memory 112, and communication interface 113. Communication interface 113 may be a network interface configured to support communication between intelligent iterative multi-version extractor platform 102 and one or more networks (e.g., network 101, or the like). Memory 112 may include one or more program modules having instructions that when executed by processor 111 cause intelligent iterative multi-version extractor platform 102 to perform one or more functions described herein and/or one or more databases that may store and/or otherwise maintain information which may be used by such program modules and/or processor 111. In some instances, the one or more program modules and/or databases may be stored by and/or maintained in different memory units of intelligent iterative multi-version extractor platform 102 and/or by different computing devices that may form and/or otherwise make up intelligent iterative multi-version extractor platform 102. For example, memory 112 may have, host, store, and/or include intelligent module 112a, intelligent database 112b, and/or machine learning engine 112c.

Intelligent module 112a may have instructions that direct and/or cause intelligent iterative multi-version extractor platform 102 to process a versioned file and output a numerical vector representation of the versioned file using a machine learning engine 112c, and/or perform other functions. Intelligent database 112b may store information used by the intelligent module 112a and/or intelligent iterative multi-version extractor platform 102 in application of techniques to efficiently store a versioned file, store differences between successive versions of the file (i.e., delta vectors), and/or perform other functions. Machine learning engine 112c may be configured and/or used by intelligent iterative multi-version extractor platform 102 and/or intelligent module 112a to refine and/or otherwise update a convolutional neural network that may reduce the size of a versioned file, and/or perform other methods described herein.

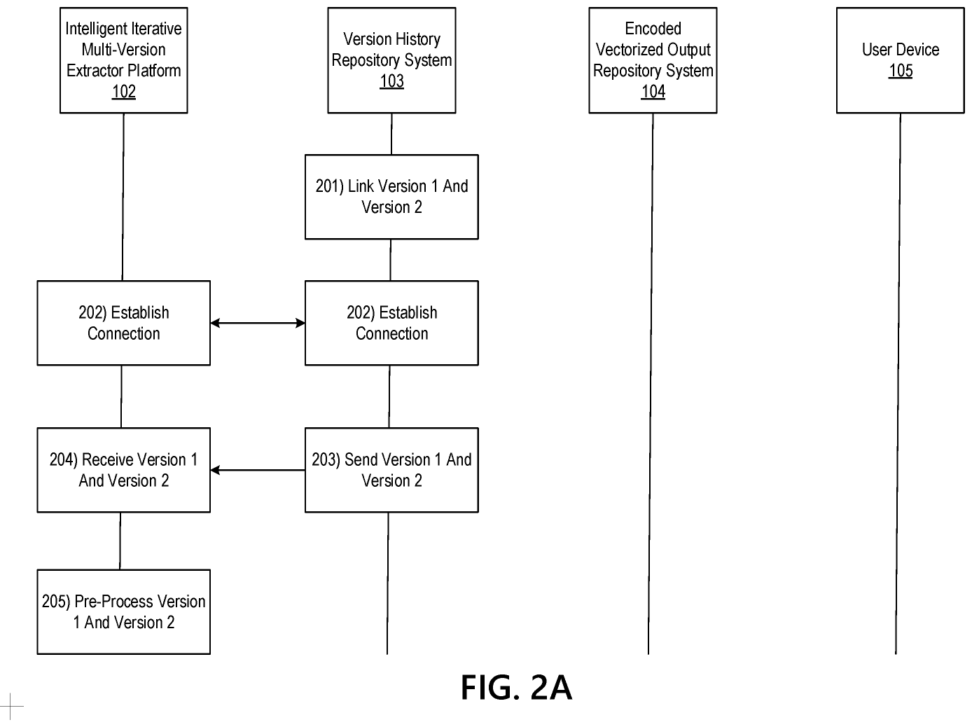

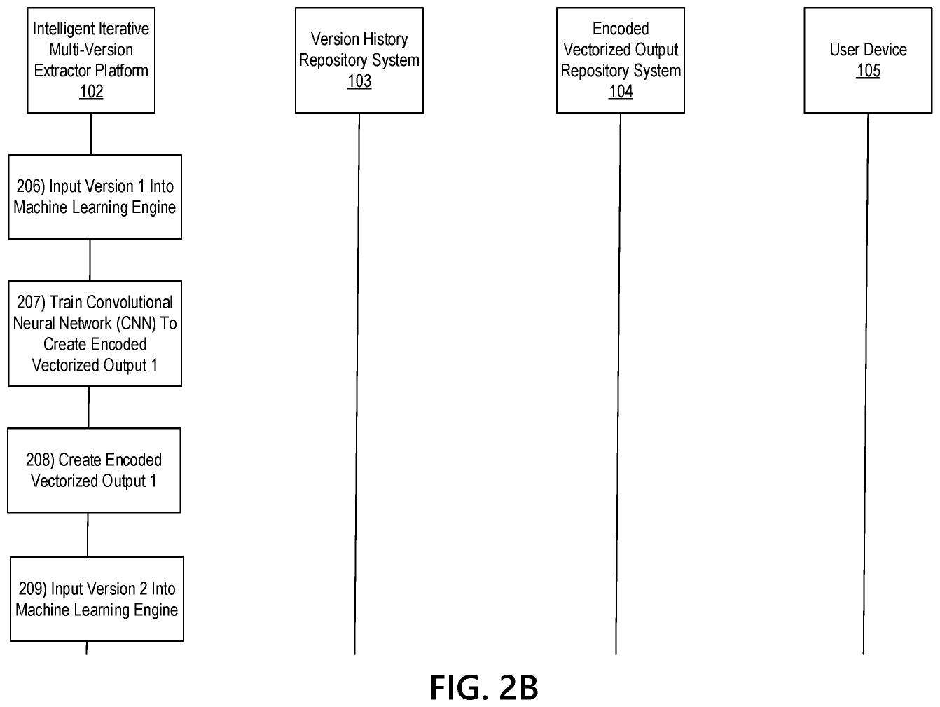

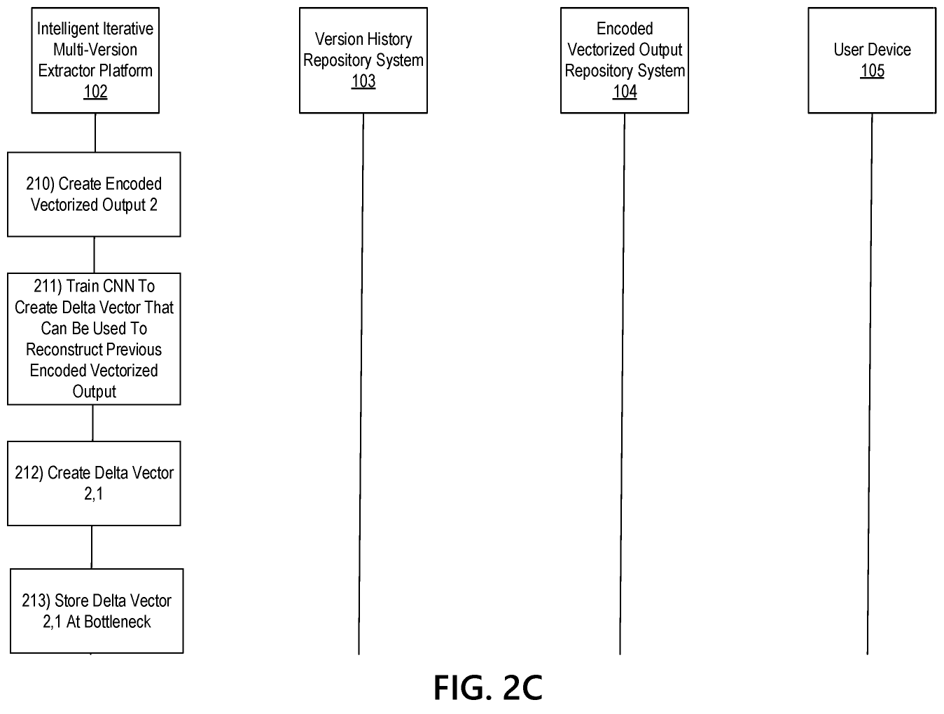

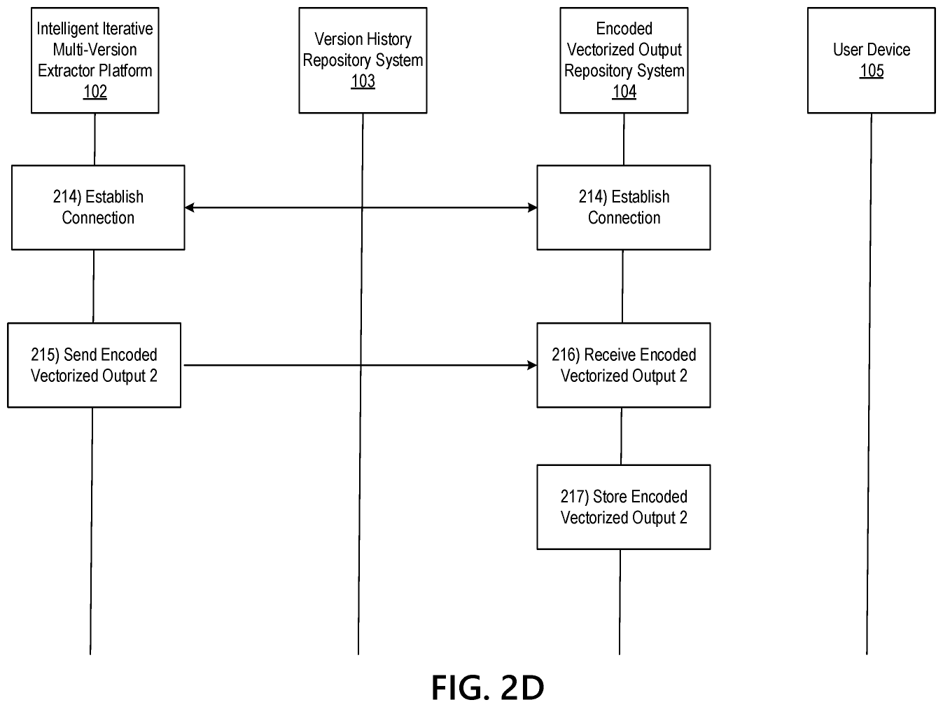

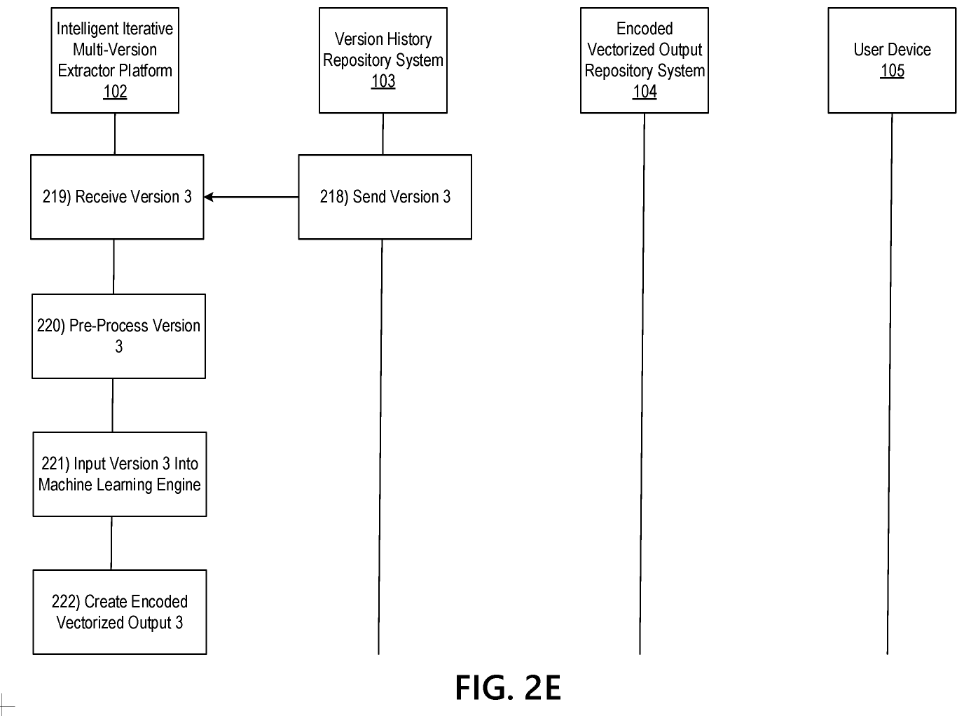

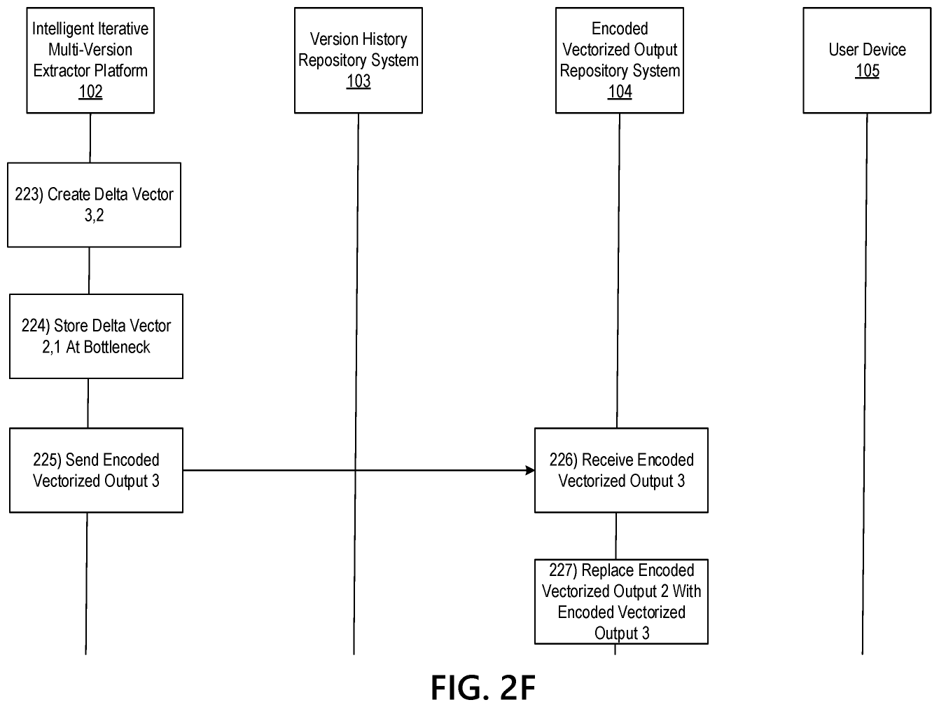

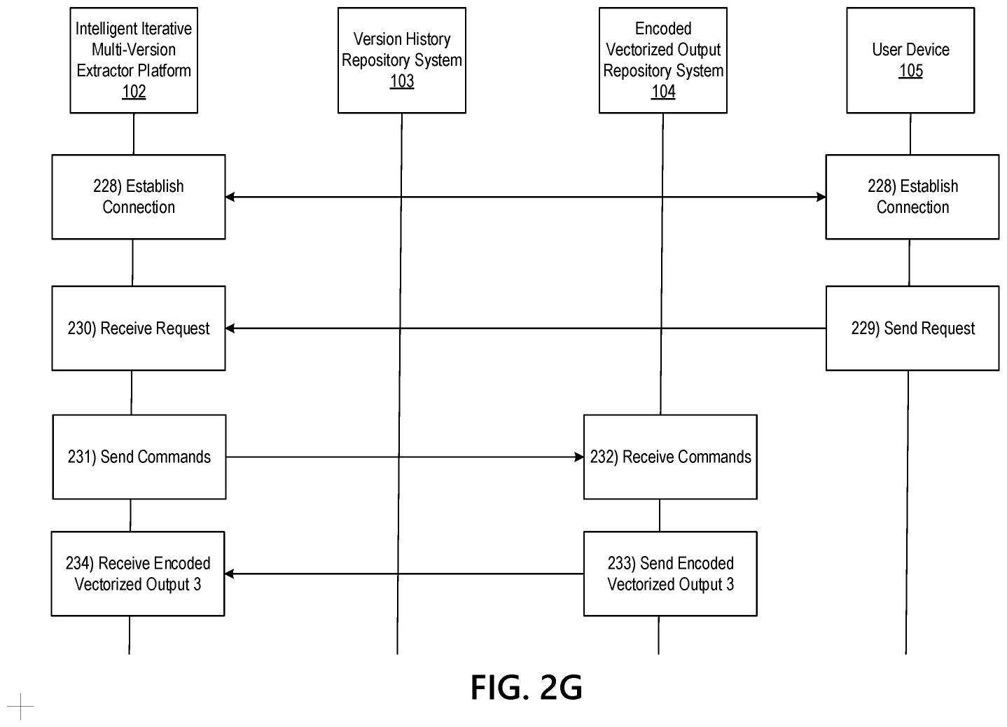

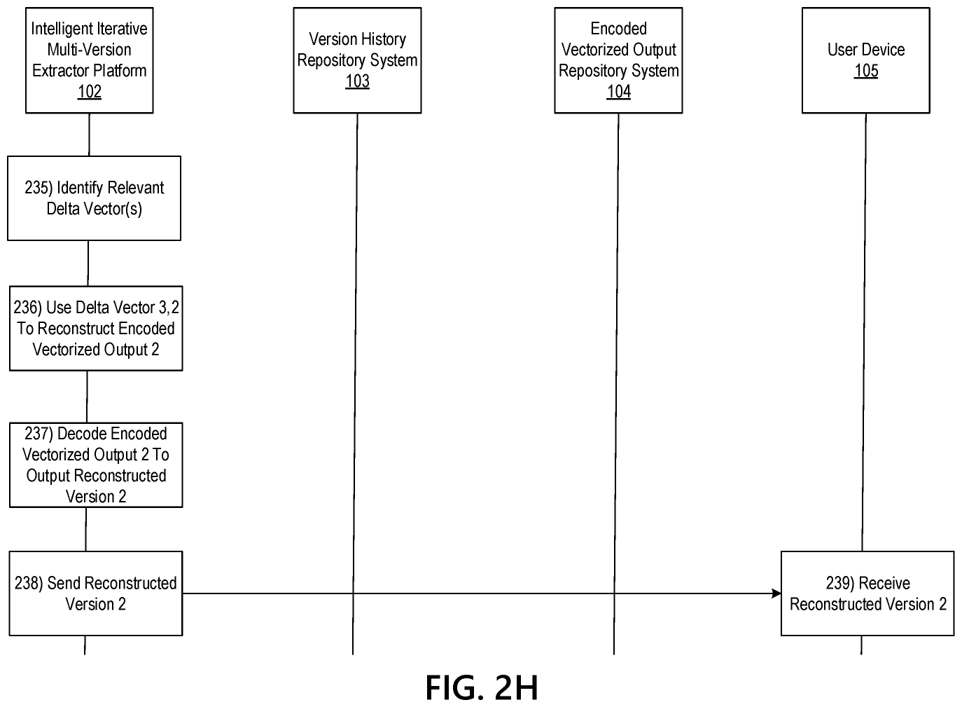

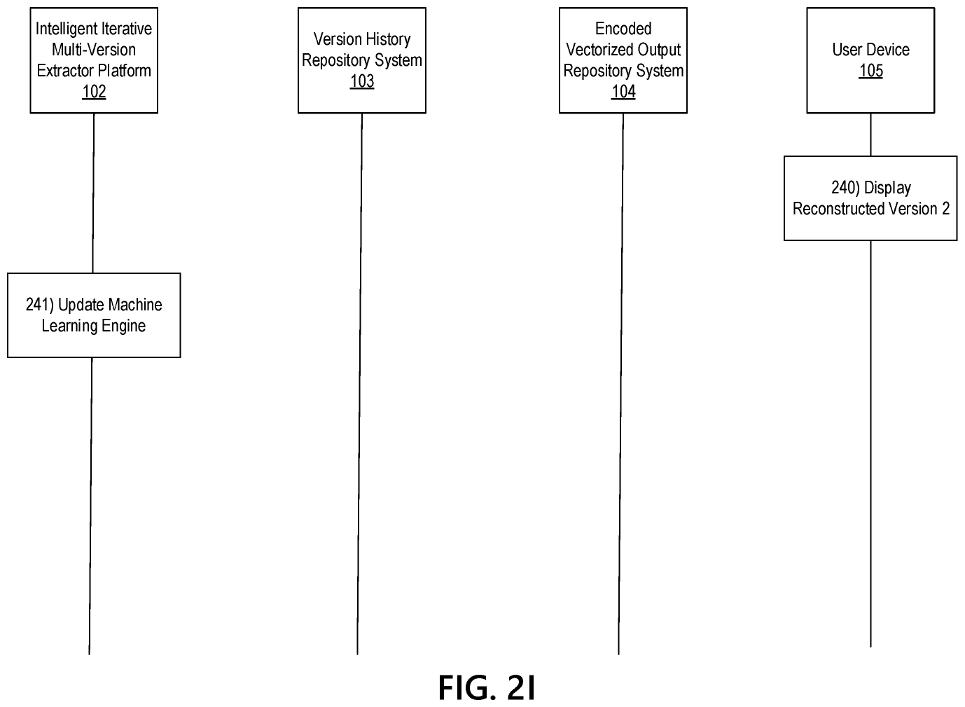

FIGS. 2A-2I depict an illustrative event sequence for implementing an intelligent iterative multi-version extractor in accordance with one or more example embodiments. Referring to FIG. 2A, at step 201, version history repository system 103 may link a first version of a file (e.g., version 1) and a second version (e.g., version 2) of the file created after the first version. The file may generally refer to, e.g., a text file, audio file, video file, software document, and/or any other type of files. Although only two versions are mentioned, there may be any number of versions without departing from the scope of the disclosure.

Linking the versions of a versioned file may generally refer to creating a logical chain between successive versions of the file (e.g., between version 1 and version 2 and/or more versions of the file). In some instances, version history repository system 103 may use metadata associated with the versioned file to link each version of the file, thereby creating a logical chain of versions of the file. For example, version 1 may be an earlier or original version of the file, and linked to version 2, which may be a later or successive version of the file.

At step 202, version history repository system 103 may establish a connection with intelligent iterative multi-version extractor platform 102. For example, version history repository system 103 may establish a first wireless data connection with intelligent iterative multi-version extractor platform 102 to link version history repository system 103 to intelligent iterative multi-version extractor platform 102 (e.g., in preparation for sending version 1 and version 2 of the file). In some instances, version history repository system 103 may identify whether or not a connection is already established with intelligent iterative multi-version extractor platform 102. If a connection is already established with intelligent iterative multi-version extractor platform 102, version history repository system 103 might not re-establish the connection. If a connection is not already established with intelligent iterative multi-version extractor platform 102, version history repository system 103 may establish the first wireless data connection as described herein.

At step 203, version history repository system 103 may send version 1 and version 2 of the file to intelligent iterative multi-version extractor platform 102. For example, version history repository system 103 may send version 1 and version 2 of the file to intelligent iterative multi-version extractor platform 102 while the first wireless data connection is established. At step 204, intelligent iterative multi-version extractor platform 102 may receive version 1 and version 2 of the file.

At step 205, intelligent iterative multi-version extractor platform 102 may pre-process version 1 and version 2 of the file. Pre-processing may generally refer to converting and/or modifying the versioned files to a machine-readable format that may be used by intelligent iterative multi-version extractor platform 102 to perform the functions described below.

For example, the versioned file may be tokenized, in which the versioned file is represented as/converted to a machine-readable tokenized format. In some instances, a vocabulary including keywords may be created, and relationships between tokens and the keywords may be established, which may be identified by intelligent iterative multi-version extractor platform 102 in furtherance of processing the file. In some instances, pre-contextual embedding may be used to provide additional context based on the previously established relationships between the tokens and keywords, which may direct intelligent iterative multi-version extractor platform 102 to, in response to identifying/detecting a keyword, search the (tokenized) file before and after the keyword for additional context.

In some instances, padding may be used to create a uniform format for the pre-processed versions of the file whereby all the versions of the file may be the same length. In pre-processing the versioned file, intelligent iterative multi-version extractor platform 102 may convert the versioned file (e.g., version 1 and version 2) into a uniform matrix format/representation that is machine-readable (i.e., readable by machine learning engine 112c).

Referring to FIG. 2B, at step 206, intelligent iterative multi-version extractor platform 102 may input version 1 into a machine learning engine. In some instances, the machine learning engine (i.e., machine learning engine 112c) may utilize unsupervised learning. For example, a deep learning process, a sub-type of unsupervised learning, may be used. In some instances, a convolutional neural network (CNN) may be used. The CNN may have multiple layers, in which each layer may be used to extract key features of the versioned file and/or perform other functions, which may reduce the size of the versioned file.

For example, machine learning engine 112c may host a CNN that may be trained to perform the functions described herein. For example, the CNN may include a hierarchical stacked convolutional auto-encoder that may convolve, vectorize, and extract the versioned file. Each convolutional layer may reduce the dimension of each version of the file until each version of the file becomes a one-dimensional vector. In some instances, the encoded vector may be decoded using a reverse of the encoding process (e.g., to reconstruct the original version from the encoded vector).

At step 207, intelligent iterative multi-version extractor platform 102 may train and/or otherwise configure the convolutional neural network (CNN) to create encoded vectorized output 1. In some instances, the CNN may have multiple layers as discussed above, in which each layer may reduce the dimensionality of the versioned file by extracting key features identified in step 205 and/or eliminating redundant information. For example, version 1 may, after being pre-processed in step 205, be a 3×3 matrix that, when fed into the CNN, is reduced into a 2×2 matrix after a first layer of the CNN, and then may be further reduced into a 1×1 flattened vector after a second layer of the CNN. In some instances, the CNN may use ReLu or Huffman coding to ensure data loss is prevented or minimized. In some instances, a pooling layer may be used to further support the convolutional layers. In some instances, a fully connected layer may be used to connect the layers of the CNN. In some instances, the CNN may include multiple layers without departing from the scope of the disclosure. In doing so, intelligent iterative multi-version extractor platform 102 may create a one-dimensional vector representation of the particular version of the file (e.g., encoded vectorized output 1) that may be used to reconstruct version 1 by reversing the process of encoding version 1 into encoded vectorized output 1.

In some instances, step 207 may be performed iteratively until a reconstruction loss threshold (e.g., 1% loss, or the like) is reached such that encoded vectorized output 1 may be used to reconstruct version 1 by reversing the process of encoding version 1 into encoded vectorized output 1 (i.e., reversing the encoding layers with a corresponding decoding layer). For example, each iteration may adjust the characteristics/parameters of each layer of the CNN's encoder until the reconstruction loss threshold is reached.

At step 208, intelligent iterative multi-version extractor platform 102 may create encoded vectorized output 1. Creating encoded vectorized output 1 may be based on the training performed in step 207. In creating encoded vectorized output 1, intelligent iterative multi-version extractor platform 102 may create a vectorized representation of version 1 that may be used to reconstruct version 1 by reversing the encoding process previous performed by the CNN.

At step 209, intelligent iterative multi-version extractor platform 102 may input version 2 into a machine learning engine. In some instances, the machine learning engine of step 209 may be the same machine learning engine as discussed in step 206.

Referring to FIG. 2C, at step 210, intelligent iterative multi-version extractor platform 102 may create encoded vectorized output 2. In some instances, creating encoded vectorized output 2 may be similar to the actions performed in in step 207 and/or step 208. In creating encoded vectorized output 2, intelligent iterative multi-version extractor platform 102 may create a vectorized representation of version 2 that may be used to reconstruct version 2 by reversing the encoding process performed by the CNN.

At step 211, intelligent iterative multi-version extractor platform 102 may train the CNN to create a delta vector that may be used to reconstruct the previous encoded vectorized output from a successive encoded vectorized output. For example, differences between two successive versions of a file (e.g., version 1 and version 2) may be identified by the CNN in creating the delta vector. In some instances, the delta vector may be a numerical vector representation of differences between successive versions of the file (e.g., between version 1 and version 2).

For example, a delta vector may be used to reconstruct a previous encoded vectorized output from a successive encoded vectorized output (e.g., outputting encoded vectorized output 1 from encoded vectorized output 2). In doing so, a successive encoded vectorized output may be used to reconstruct the previous encoded vectorized output using the corresponding delta vector, which then may then be decoded to output the actual previous version (e.g., version 1).

In some instances, step 211 may be performed iteratively until a reconstruction loss threshold (e.g., 1% loss) is reached such that encoded vectorized output 2 may be used to reconstruct encoded vectorized output 1 using delta vector 2,1, which in turn may be decoded to output version 1.

At step 212, intelligent iterative multi-version extractor platform 102 may create delta vector 2,1. Creating delta vector 2,1 may be based on the training performed in step 211. For example, delta vector 2,1 may correspond to differences between version 1 and version 2 of the file, and may be used to output encoded vectorized output 1 from encoded vectorized output 2.

At step 213, intelligent iterative multi-version extractor platform 102 may store delta vector 2,1 at a bottleneck. In some instances, the bottleneck may represent a storage device, such as a database. For example, a bottleneck may be located at the machine learning engine 112c. In some instances, the bottleneck may be located at the intelligent database 112b. In some instances, the bottleneck may be used to securely store delta vectors.

Referring to FIG. 2D, at step 214, intelligent iterative multi-version extractor platform 102 may establish a connection with encoded vectorized output repository system 104. For example, intelligent iterative multi-version extractor platform 102 may establish a second wireless data connection with encoded vectorized output repository system 104 to link intelligent iterative multi-version extractor platform 102 to encoded vectorized output repository system 104 (e.g., in preparation for sending encoded vectorized output 2). In some instances, intelligent iterative multi-version extractor platform 102 may identify whether or not a connection is already established with encoded vectorized output repository system 104. If a connection is already established with encoded vectorized output repository system 104, intelligent iterative multi-version extractor platform 102 might not re-establish the connection. If a connection is not already established with encoded vectorized output repository system 104, intelligent iterative multi-version extractor platform 102 may establish the second wireless data connection as described herein.

At step 215, intelligent iterative multi-version extractor platform 102 may send encoded vectorized output 2 to encoded vectorized output repository system 104. For example, intelligent iterative multi-version extractor platform 102 may send encoded vectorized output 2 to encoded vectorized output repository system 104 while the second wireless data connection is established.

At step 216, encoded vectorized output repository system 104 may receive encoded vectorized output 2. At step 217, encoded vectorized output repository system 104 may store encoded vectorized output 2. In storing encoded vectorized output 2 at encoded vectorized output repository system 104, encoded vectorized output 2 may be securely stored such that if accessed by a malicious actor, encoded vectorized output 2 might not be decoded without access to intelligent iterative multi-version extractor platform 102, because decoding encoded vectorized output 2 may be performed based on reversing the encoding process performed by the CNN. In some instances, there may be significant efficiency and reduced memory usage in storing a single encoded vectorized output that may be used to reconstruct any version of the file, without having to store all versions of the file.

The previous steps 205-217 generally refer to receiving a versioned file from version history repository system 103 all at once (e.g., versions 1, 2, etc. are sent). The below steps 218-227 generally refer to instances when a new version of the file is created and sent to intelligent iterative multi-version extractor platform 102 (e.g., a version not previously sent, such as version 3, etc.).

Referring to FIG. 2E, at step 218, version history repository system 103 may send version 3 of the file. For example, version history repository system 103 may send version 3 of the file to intelligent iterative multi-version extractor platform 102 while the first wireless data connection is established. At step 219, intelligent iterative multi-version extractor platform 102 may receive version 3.

At step 220, intelligent iterative multi-version extractor platform 102 may pre-process version 3. The pre-processing may be similar to the pre-processing performed in step 205. At step 221, intelligent iterative multi-version extractor platform 102 may input version 3 into a machine learning engine. In some instances, the machine learning engine may be the same machine learning engine as in step 206 and/or step 209.

At step 222, intelligent iterative multi-version extractor platform 102 may create encoded vectorized output 3. Creating encoded vectorized output 3 may be similar to the actions performed in step 207 and/or step 208. In this manner, the CNN may be trained and/or otherwise used to output encoded vectorized output 3, which may subsequently be used to reconstruct version 3 by reversing the encoding process used to create encoded vectorized output 3. In some instances, step 222 may be performed iteratively until a reconstruction loss threshold (e.g., 1% loss) is reached such that encoded vectorized output 3 may be used to output version 3.

Referring to FIG. 2F, at step 223, intelligent iterative multi-version extractor platform 102 may create delta vector 3,2. Creating delta vector 3,2 may be done similarly to the actions performed in step 211 and/or step 212. In this manner, the CNN may be used to output delta vector 3,2 that may be used to reconstruct encoded vectorized output 2 from encoded vectorized output 3. In some instances, step 223 may be performed iteratively until a reconstruction loss threshold (e.g., 1% loss) is reached such that delta vector 3,2 may be used to output encoded vectorized output 2 from encoded vectorized output 3, which in turn may be decoded to output version 2.

At step 224, intelligent iterative multi-version extractor platform 102 may store delta vector 3,2 at the bottleneck. For example, a bottleneck may be located at the machine learning engine 112c. In some instances, the bottleneck may be located at the intelligent database 112b. In some instances, delta vector 3,2 may be stored at the same bottleneck as delta vector 2,1 was stored.

At step 225, intelligent iterative multi-version extractor platform 102 may send encoded vectorized output 3 to the encoded vectorized output repository system 104. For example, intelligent iterative multi-version extractor platform 102 may send encoded vectorized output 3 to encoded vectorized output repository system 104 while the second wireless data connection is established. In some instances, intelligent iterative multi-version extractor platform 102 may additionally send commands to encoded vectorized output repository system 104 directing encoded vectorized output repository system 104 to replace encoded vectorized output 2 with encoded vectorized output 3.

At step 226, encoded vectorized output repository system 104 may receive encoded vectorized output 3. At step 227, encoded vectorized output repository system 104 may replace encoded vectorized output 2 with encoded vectorized output 3. In some instances, encoded vectorized output repository system 104 may replace encoded vectorized output 2 with encoded vectorized output 3 based on commands sent from the intelligent iterative multi-version extractor platform 102.

In replacing encoded vectorized output 2 with encoded vectorized output 3, intelligent iterative multi-version extractor platform 102 may continually receive new versions of file, create new encoded vectorized outputs that may be used to reconstruct any previous version, and store the most recent version at encoded vectorized output repository system 104 for future use. In doing so, there may be a current encoded vectorized output at encoded vectorized output repository system 104, which may reduce memory usage and storage costs as the size of the versioned file exponentially increases over time.

The following steps 228-240 generally describe a user device 105 requesting a particular version of the file (such as versions 1, 2, 3, or the like described in the illustrative example discussed herein) from intelligent iterative multi-version extractor platform 102.

Referring to FIG. 2G, at step 228, intelligent iterative multi-version extractor platform 102 may establish a connection with user device 105. For example, user device 105 may establish a third wireless data connection with intelligent iterative multi-version extractor platform 102 to link user device 105 to intelligent iterative multi-version extractor platform 102 (e.g., in preparation for sending a request for a previous version of the file). In some instances, user device 105 may identify whether or not a connection is already established with intelligent iterative multi-version extractor platform 102. If a connection is already established with intelligent iterative multi-version extractor platform 102, user device 105 might not re-establish the connection. If a connection is not already established with intelligent iterative multi-version extractor platform 102, user device 105 may establish the third wireless data connection as described herein.

At step 229, user device 105 may send a request for a particular version of the file (e.g., version 2) to intelligent iterative multi-version extractor platform 102. For example, user device 105 may send the request to intelligent iterative multi-version extractor platform 102 while the third wireless data connection is established. In some instances, there may be multiple user devices sending multiple requests for various versions of the file simultaneously.

At step 230, intelligent iterative multi-version extractor platform 102 may receive the request for the particular version of the file. At step 231, intelligent iterative multi-version extractor platform 102 may send commands based on the request to encoded vectorized output repository system 104. For example, the commands may direct encoded vectorized output repository system 104 to send the encoded vectorized output (e.g., encoded vectorized output 3) that was previously stored, in order to reconstruct the particular version of the file user device 105 previously requested. For example, intelligent iterative multi-version extractor platform 102 may send the commands to encoded vectorized output repository system 104 while the second wireless data connection is established.

At step 232, encoded vectorized output repository system 104 may receive the commands to send encoded vectorized output 3 to intelligent iterative multi-version extractor platform 102. At step 233, encoded vectorized output repository system 104 may send encoded vectorized output 3 to intelligent iterative multi-version extractor platform 102 based on the commands from intelligent iterative multi-version extractor platform 102. For example, encoded vectorized output repository system 104 may send encoded vectorized output 3 to intelligent iterative multi-version extractor platform 102 while the second wireless data connection is established. At step 234, intelligent iterative multi-version extractor platform 102 may receive encoded vectorized output 3 based on the commands previously sent in step 231.

Referring to FIG. 2H, at step 235, intelligent iterative multi-version extractor platform 102 may identify relevant delta vectors. For example, if the request is for version 2, then delta vector 3,2 may be identified as being necessary to output encoded vectorized output 2 using encoded vectorized output 3.

At step 236, intelligent iterative multi-version extractor platform 102 may use an identified relevant delta vector, such as delta vector 3,2 based on the example above, to output encoded vectorized output 2 by accessing the bottleneck where delta vector 3, 2 was previously stored. At step 237, intelligent iterative multi-version extractor platform 102 may decode encoded vectorized output 2 to output the actual version 2 (e.g., by reversing the encoding layers that were used to create encoded vectorized output 2 with corresponding decoding layers).

At step 238, intelligent iterative multi-version extractor platform 102 may send reconstructed version 2. For example, intelligent iterative multi-version extractor platform 102 may send the reconstructed version 2 to user device 105 while the third wireless data connection is established. In some instances, intelligent iterative multi-version extractor platform 102 may additionally send commands directing user device 105 to display version 2. At step 239, user device 105 may receive the reconstructed version 2.

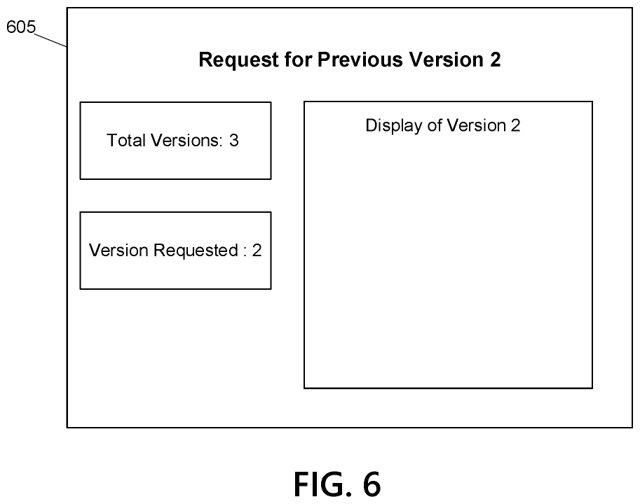

Referring to FIG. 2I, at step 240, user device 105 may display version 2. In some instances, the display may be similar to the graphical user interface 605 depicted in FIG. 6. For example, the display may show the total number of versions of the file, which particular version was requested by user device 105, and a display of that particular version.

Although the previous steps 229-240 are described with respect to user device 105 requesting version 2, user device 105 may request any version of the file, and intelligent iterative multi-version extractor platform 102 may identify relevant delta vectors for reconstructing the particular version requested by user device 150. For example, if the request is for version 1, then both delta vector 3,2 and delta vector 2,1 may be identified for use in outputting encoded vectorized output 1 using encoded vectorized output 3.

At step 241, intelligent iterative multi-version extractor platform 102 may update the machine learning engine. In some instances, the updating may be based on new versions received by intelligent iterative multi-version extractor platform 102. In some instances, the machine learning engine may be updated based on new versions, new types of files (e.g., video instead of text), the number of iterations need to reach a particular reconstruction loss threshold, and/or other methods.

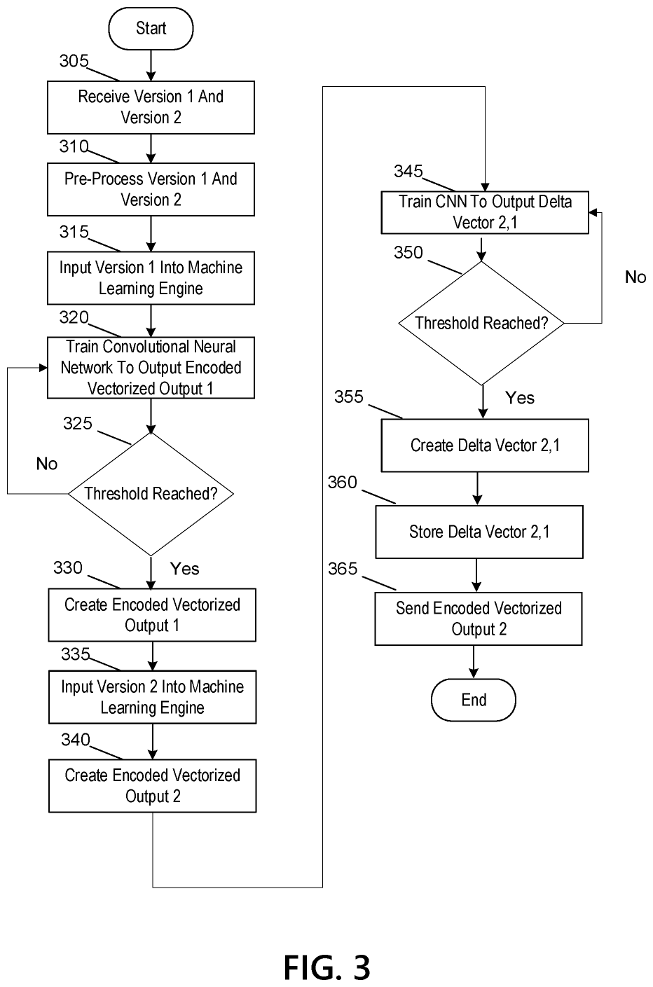

FIG. 3 depicts an illustrative method for implementing an intelligent iterative multi-version extractor in accordance with one or more example embodiments. At step 305, a computing platform having at least one processor, a communication interface, and memory may receive a first version (e.g., version 1) and a second version (e.g., version 2) of a file. At step 310, the computing platform may pre-process the first and second versions of the file.

At step 315, the computing platform may input the first version into a machine learning engine. At step 320, the computing platform may train a convolutional neural network (CNN) associated with the machine learning engine to output a first encoded vectorized output (e.g., encoded vectorized output 1) that may be used to reconstruct the first version of the file (e.g., version 1).

At step 325, the computing platform may detect whether a reconstruction loss threshold has been reached. If the threshold has not been reached, the computing platform may re-execute step 320 until the threshold has been reached. If the threshold has been reached, the computing platform may proceed to step 330.

At step 330, the computing platform may create (e.g., based on the output first encoded vectorized output processed until the reconstruction loss threshold is reached) the first encoded vectorized output (e.g., encoded vectorized output 1). At step 335, the computing platform may input the second version of the file (e.g., version 2) into the machine learning engine. At step 340, the computing system may create a second encoded vectorized output (e.g., encoded vectorized output 2). In some instances, steps 320 and 325 may be similarly performed to create the second encoded vectorized output.

At step 345, the computing platform may train the CNN to output a delta vector corresponding to the two versions of the file (e.g., delta vector 2,1) that may be used to output the previous first encoded vectorized output (e.g., encoded vectorized output 1). At step 350, the computing platform may detect whether a reconstruction loss threshold has been reached. If the threshold has been reached, the computing platform may re-execute step 345 until the threshold has been reached. If the reconstruction loss threshold has been reached, the computing platform may proceed to step 355.

At step 355, the computing platform may create (e.g., based on the output delta vector processed until the reconstruction loss threshold is reached) delta vector 2,1. At step 360, the computing platform may store delta vector 2,1 at a bottleneck associated with the machine learning engine. At step 365, the computing platform may send the second encoded vectorized output (e.g., encoded vectorized output 2) to encoded vectorized output repository system 104.

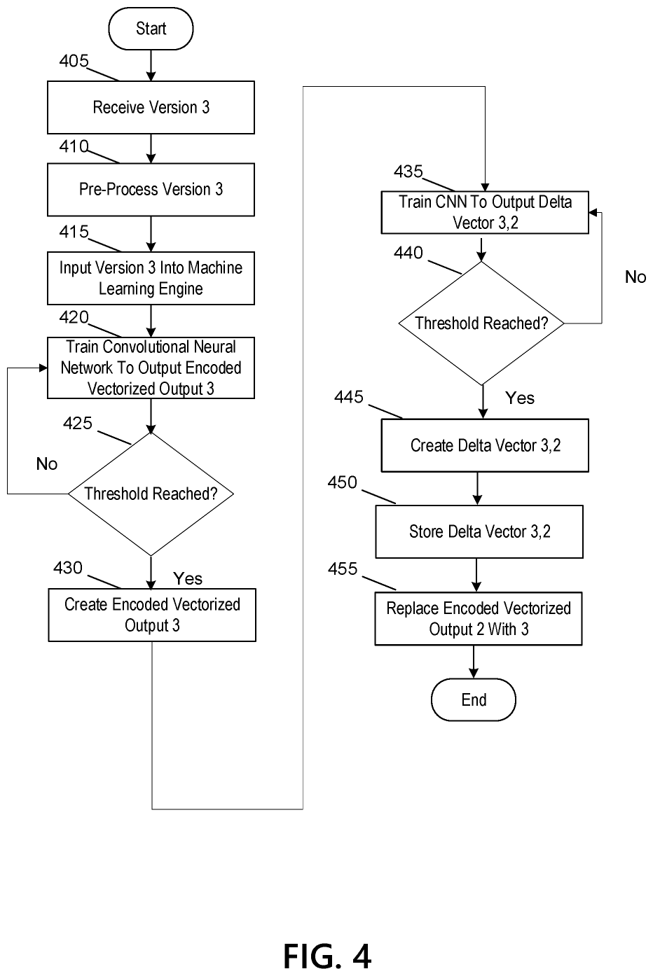

FIG. 4 depicts an illustrative method for implementing an intelligent iterative multi-version extractor in accordance with one or more example embodiments. At step 405, a computing platform having at least one processor, a communication interface, and memory may receive a new version of the file (e.g., version 3 of the file). At step 410, the computing platform may pre-process the new version (e.g., version 3). At step 415, the computing platform may input version 3 into a machine learning engine.

At step 420, the computing platform may train a convolutional neural network (CNN) associated with the machine learning engine to output a third encoded vectorized output (e.g., encoded vectorized output 3) that may be used to reconstruct the new version (e.g., version 3). At step 425, the computing platform may detect whether a reconstruction loss threshold has been reached. If the threshold has not been reached, the computing platform may re-execute step 420 until the threshold has been reached. If the threshold has been reached, the computing platform may proceed to step 430.

At step 430, the computing platform may create (e.g., based on the output third encoded vectorized output processed until the reconstruction loss threshold is reached) a new encoded vectorized output (e.g., encoded vectorized output 3). At step 435, the computing platform may train the CNN to output a new delta vector (e.g., delta vector 3,2) that may be used to reconstruct the previous encoded vectorized output 2.

At step 440, the computing platform may detect whether a reconstruction loss threshold has been reached. If the threshold has been reached, the computing platform may re-execute step 435 until the threshold has been reached. If the reconstruction loss threshold has been reached, the computing platform may proceed to step 445.

At step 445, the computing platform may create (e.g., based on the output new delta vector processed until the reconstruction loss threshold is reached) the new delta vector (e.g., create delta vector 3,2). At step 450, the computing platform may store delta vector 3,2 at a bottleneck associated with the machine learning engine. At step 455, the computing platform may replace encoded vectorized output 2 with encoded vectorized output 3 at encoded vectorized output repository system 104.

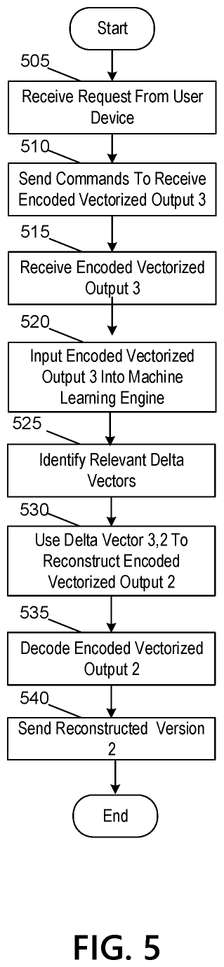

FIG. 5 depicts an illustrative method for implementing an intelligent iterative multi-version extractor in accordance with one or more example embodiments. At step 505, a computing platform having at least one processor, a communication interface, and memory may receive a request for a previous version of the file (e.g., version 2).

At step 510, the computing platform may send commands to encoded vectorized output repository system 104 to send the current encoded vectorized output (e.g., encoded vectorized output 3) to the computing platform. In response to the commands to send encoded vectorized output 3, at step 515, the computing platform may receive encoded vectorized output 3. At step 520, the computing platform may input encoded vectorized output 3 into the machine learning engine.

At step 525, the computing platform may identify relevant delta vectors (e.g., delta vector 3,2), based on the received encoded vectorized output (e.g., encoded vectorized output 3) and the request. At step 530, the computing platform may use delta vector 3,2 to reconstruct encoded vectorized output 2 from encoded vectorized output 3.

At step 535, the computing platform may decode encoded vectorized output 2 to output the particular version requested by user device 105 (e.g., version 2). At step 540, the computing platform may send the reconstructed version 2 to the user device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, based on a plurality of versions of a file, a convolutional neural network, wherein training the convolutional neural network configures the convolutional neural network to:
create a plurality of encoded vectorized outputs corresponding to the plurality of versions, wherein each of the plurality of encoded vectorized outputs comprises a one-dimensional vector that corresponds to a respective encoded vectorized output;
create a plurality of delta vectors, wherein each of the plurality of delta vectors corresponds to differences between successive versions of the file and may be used to obtain a previous version from a newer version; and
store, at a first repository, a newest encoded vectorized output;
receive, from a user device, a request to obtain a previous version of the file;
send, based on the request, one or more commands directing the first repository to send the newest encoded vectorized output to the computing platform, wherein sending the one or more commands directing the first repository to send the newest encoded vectorized output to the computing platform causes the first repository to send the newest encoded vectorized output to the computing platform;
receive, from the first repository, the newest encoded vectorized output;
input the newest encoded vectorized output into the convolutional neural network;
output, using the convolutional neural network, the previous version of the file from the newest encoded vectorized output using a corresponding delta vector of the plurality of delta vectors; and
send, to the user device, the previous version of the file and one or more commands directing the user device to display the previous version of the file, wherein sending the one or more commands directing the user device to display the previous version of the file causes the user device to display the previous version of the file.

2. The computing platform of claim 1, wherein the training further configures the convolutional neural network to:
receive, from a second repository, a first version of the file and a second version of the file, wherein the first version and the second version are successive versions of the file;
input, into the convolutional neural network, the first version and the second version;
create, using the convolutional neural network, a first encoded vectorized output corresponding to the first version and a second encoded vectorized output corresponding to the second version;
create, using the convolutional neural network, a first delta vector between the first encoded vectorized output and the second encoded vectorized output, wherein the first delta vector may be used to obtain the first version from the second version; and
store, at the first repository, the second encoded vectorized output.

3. The computing platform of claim 1, wherein the convolutional neural network further comprises a first layer and a second layer, wherein each of the first layer and the second layer reduces a dimensionality of each of the plurality of versions.

4. The computing platform of claim 1, wherein the creating the plurality of encoded vectorized outputs is performed iteratively until a reconstruction loss threshold is reached so that each of the plurality of encoded vectorized outputs may be used to output the corresponding plurality of versions.

5. The computing platform of claim 1, wherein the creating the plurality of delta vectors is performed iteratively until a reconstruction loss threshold is reached that enables each of the plurality of delta vectors to be used to obtain previous encoded vectorized outputs from successive encoded vectorized outputs.

6. The computing platform of claim 1, wherein the memory stores computer-readable instructions that, when executed by the at least one processor, further cause the computing platform to:
store the plurality of versions of the file at a second repository.

7. The computing platform of claim 1, wherein the memory stores computer-readable instructions that, when executed by the at least one processor, further cause the computing platform to:
store the plurality of delta vectors at a bottleneck associated with the convolutional neural network.

8. The computing platform of claim 1, wherein the memory stores computer-readable instructions that, when executed by the at least one processor, further cause the computing platform to:
pre-process the plurality of versions of the file before training the convolutional neural network, wherein the pre-processing comprises converting the plurality of versions of the file into a machine-readable format by tokenizing the plurality of versions of the file.

9. The computing platform of claim 2, wherein the training further configures the convolutional neural network to:
receive, from the second repository, a third version of the file, wherein the third version is a successive version of the second version of the file;
input, into the convolutional neural network, the third version;
create, using the convolutional neural network, a third encoded vectorized output corresponding to the third version; and
create, using the convolutional neural network, a second delta vector between the second encoded vectorized output and the third encoded vectorized output, wherein the second delta vector may be used to obtain the second version from the third version.

10. The computing platform of claim 9, wherein the training further configures the convolutional neural network to:
send the third encoded vectorized output and one or more commands directing the first repository to replace the second encoded vectorized output with the third encoded vectorized output, wherein sending the third encoded vectorized output and one or more commands directing the first repository to replace the second encoded vectorized output with the third encoded vectorized output causes the first repository to replace the second encoded vectorized output with the third encoded vectorized output.

11. A method comprising:
at a computing platform comprising at least one processor, a communication interface, and memory:
training, based on a plurality of versions of a file, a convolutional neural network, wherein training the convolutional neural network configures the convolutional neural network to:
create a plurality of encoded vectorized outputs corresponding to the plurality of versions, wherein each of the plurality of encoded vectorized outputs comprises a one-dimensional vector that corresponds to a respective encoded vectorized output;
create a plurality of delta vectors, wherein each of the plurality of delta vectors corresponds to differences between successive versions of the file and may be used to obtain a previous version from a newer version; and
store, at a first repository, a newest encoded vectorized output;
receiving, from a user device, a request to obtain a previous version of the file;
sending, based on the request, one or more commands directing the first repository to send the newest encoded vectorized output to the computing platform, wherein sending the one or more commands directing the first repository to send the newest encoded vectorized output to the computing platform causes the first repository to send the newest encoded vectorized output to the computing platform;
receiving, from the first repository, the newest encoded vectorized output;
inputting the newest encoded vectorized output into the convolutional neural network;
outputting, using the convolutional neural network, the previous version of the file from the newest encoded vectorized output using a corresponding delta vector of the plurality of delta vectors; and
sending, to the user device, the previous version of the file and one or more commands directing the user device to display the previous version of the file, wherein sending the one or more commands directing the user device to display the previous version of the file causes the user device to display the previous version of the file.

12. The method of claim 11, wherein the training further configures the convolutional neural network to:
receive, from a second repository, a first version of the file and a second version of the file, wherein the first version and the second version are successive versions of the file;
input, into the convolutional neural network, the first version and the second version;
create, using the convolutional neural network, a first encoded vectorized output corresponding to the first version and a second encoded vectorized output corresponding to the second version;
create, using the convolutional neural network, a first delta vector between the first encoded vectorized output and the second encoded vectorized output, wherein the first delta vector may be used to obtain the first version from the second version; and
store, at the first repository, the second encoded vectorized output.

13. The method of claim 11, wherein the convolutional neural network further comprises a first layer and a second layer, wherein each of the first layer and the second layer reduces a dimensionality of each of the plurality of versions.

14. The method of claim 11, wherein the creating the plurality of encoded vectorized outputs is performed iteratively until a reconstruction loss threshold is reached so that each of the plurality of encoded vectorized outputs may be used to output the corresponding plurality of versions.

15. The method of claim 11, wherein the creating the plurality of delta vectors is performed iteratively until a reconstruction loss threshold is reached that enables each of the plurality of delta vectors to be used to obtain previous encoded vectorized outputs from successive encoded vectorized outputs.

16. The method of claim 11, further comprising storing the plurality of delta vectors at a bottleneck associated with the convolutional neural network.

17. The method of claim 11, further comprising pre-processing the plurality of versions of the file before training the convolutional neural network, wherein the pre-processing comprises converting the plurality of versions of the file into a machine-readable format by tokenizing the plurality of versions of the file.

18. The method of claim 12, wherein the training further configures the convolutional neural network to:
receive, from the second repository, a third version of the file, wherein the third version is a successive version of the second version of the file;
input, into the convolutional neural network, the third version;
create, using the convolutional neural network, a third encoded vectorized output corresponding to the third version; and
create, using the convolutional neural network, a second delta vector between the second encoded vectorized output and the third encoded vectorized output, wherein the second delta vector may be used to obtain the second version from the third version.

19. The method of claim 18, further comprising sending the third encoded vectorized output and one or more commands directing the first repository to replace the second encoded vectorized output with the third encoded vectorized output, wherein sending the third encoded vectorized output and one or more commands directing the first repository to replace the second encoded vectorized output with the third encoded vectorized output causes the first repository to replace the second encoded vectorized output with the third encoded vectorized output.

20. One or more non-transitory computer-readable media storing instructions that, when executed by a computing platform comprising at least one processor, a communication interface, and memory, cause the computing platform to:
train, based on a plurality of versions of a file, a convolutional neural network, wherein training the convolutional neural network configures the convolutional neural network to:
create a plurality of encoded vectorized outputs corresponding to the plurality of versions, wherein each of the plurality of encoded vectorized outputs comprises a one-dimensional vector that corresponds to a respective encoded vectorized output;
create a plurality of delta vectors, wherein each of the plurality of delta vectors corresponds to differences between successive versions of the file and may be used to obtain a previous version from a newer version; and
store, at a first repository, a newest encoded vectorized output;
receive, from a user device, a request to obtain a previous version of the file;
send, based on the request, one or more commands directing the first repository to send the newest encoded vectorized output to the computing platform, wherein sending the one or more commands directing the first repository to send the newest encoded vectorized output to the computing platform causes the first repository to send the newest encoded vectorized output to the computing platform;
receive, from the first repository, the newest encoded vectorized output;
input the newest encoded vectorized output into the convolutional neural network;
output, using the convolutional neural network, the previous version of the file from the newest encoded vectorized output using a corresponding delta vector of the plurality of delta vectors; and
send, to the user device, the previous version of the file and one or more commands directing the user device to display the previous version of the file, wherein sending the one or more commands directing the user device to display the previous version of the file causes the user device to display the previous version of the file.
